(19) United States
(12) Patent Application Publication
(10) Pub. No.: US 2025/0223505 A1
(43) Pub. Date: Jul. 10, 2025

(54) EMBEDDED SLURRY-PHASE HYDROCRACKING CATALYST PARTICLES, METHOD OF MAKING AND METHOD OF RECYCLING WASTE PLASTICS

(71) Applicant: SAUDI ARABIAN OIL COMPANY, Dhahran (SA)

(72) Inventors: Omer Refa Koseoglu, Istanbul (TR); Guanghui Zhu, Dhahran (SA)

(73) Assignee: SAUDI ARABIAN OIL COMPANY, Dhahran (SA)

(21) Appl. No.: 18/406,893

(22) Filed: Jan. 8, 2024

(51) Int. Cl. C10G 47/26; B01J 23/24; B01J 23/46; B01J 23/74; B01J 31/22; B01J 35/00; B01J 35/30; B01J 35/40; B01J 37/00; B01J 37/02; B01J 37/08; C10G 1/08; C10G 1/10

(52) U.S. Cl. CPC C10G 47/26; B01J 23/24; B01J 23/462; B01J 23/74; B01J 31/226; B01J 35/19; B01J 35/399; B01J 35/40; B01J 37/0063; B01J 37/0081; B01J 37/0203; B01J 37/0219; B01J 37/0234; B01J 37/08; C10G 1/086; C10G 1/10; C10G 2300/107; C10G 2300/1077; C10G 2300/4006; C10G 2300/4012; C10G 2300/4018; C10G 2300/70

(57) ABSTRACT

The present disclosure relates to methods for manufacturing embedded slurry-phase hydrocracking catalyst particles having catalytic material embedded in a plastic carrier. Catalytic material effective for slurry-phase hydrocracking, and molten plastic materials, are mixed, and the embedded slurry-phase hydrocracking catalyst particles are formed from the mixture.

### FIELD OF THE DISCLOSURE

The present disclosure relates to slurry-phase hydrocracking catalysts and methods of recycling waste plastics.

### BACKGROUND OF THE DISCLOSURE

Rising demand for transportation fuels and increasing stocks of high sulfur residual oil have resulted in a renewed interest in the processing of heavy residue to generate useful lighter fuels and chemicals. The residual oils are of low quality because of the presence of impurities like Conradson carbon residue (CCR), asphaltenes, sulfur, nitrogen, and heavy metals.

Technologies available to process these residual oils generally can be categorized as carbon rejection processes or hydrogen addition processes. Carbon rejection processes include visbreaking, fluid catalytic cracking and coking. Hydrogen addition processes include fixed-bed hydroprocessing such as hydrodesulfurization, ebullated-bed hydrocracking, hydrovisbreaking, hydropyrolysis and slurry-phase hydrocracking.

Slurry phase hydrocracking technology is attractive because feeds can include residual oils containing up to 4,000 ppm of metals (Ni+V), and achieve up to 95 V % conversion. Slurry-phase hydrocracking processes generally entail mixing an initial heavy hydrocarbon feed, hydrogen and catalysts together as a slurry, and passing the slurry through a confined hydrocracking zone to produce cracked products. The reaction dynamics include thermocracking, in which catalyst and hydrogen inhibit coke formation by hydrogenating the coke precursor and removing heteroatoms. In addition, the catalyst acts as a supporter of coke and minimizes coking of the reactor wall. The slurry-phase hydrocracking catalysts are single-use catalysts, and as such deactivation is not a concern. The initial heavy hydrocarbon feeds used in slurry-phase hydrocracking include generally inferior feeds, such as vacuum residues or other bottoms streams which typically contain high concentrations of sulfur-, nitrogen- and metal-containing compounds.

Studies have been conducted related to converting heavy vacuum residues and above into light hydrocarbons such as naphtha and diesel. A slurry-phase hydrocracking process that converts heavy vacuum residues in the presence of hydrogen and solid catalyst particles or soluble catalysts has been reported by Zhang et al., “A Review of Slurry-Phase Hydrocracking Heavy Oil Technology”, in Energy & Fuels, 2007, 21 (6), 3057-3062. The slurry-phase hydrocracking technology is based on thermocracking. The process differs from the conventional thermocracking processes since it mixes the feed oil, hydrogen and dispersed unsupported catalysts particles together. It appears that hydrogen is consumed principally to cap free radicals formed by thermocracking. See Matsumura et al., “Hydrocracking Marlim Vacuum Residue With Natural Limonite. Part 2: Experimental Cracking In A Slurry-Type Continuous Reactor”, Fuel, 2005, 84, 417-421, 420. Heavy residue oil, VGO and low-value refractory pitch streams that normally cannot be economically upgraded or even blended into other products such as fuel oil or synthetic crude oil due to their high viscosity and solids content can be processed by slurry hydrocracking technology.

During the slurry hydrocracking process described above, any solid heterogeneous catalyst(s) used must be recovered and/or removed after their catalytic activity falls below a predetermined efficacy, i.e., when the catalyst is deemed to be spent. One study suggests that the catalysts are single-use because they are deactivated by the high concentrations of sulfurous and nitrogenous compounds as well as the high molecular weight organometallic complexes. See, Zhang et al., “A Review of Slurry-Phase Hydrocracking Heavy Oil Technology”, in Energy & Fuels, 2007, 21 (6), 3057-3062 at 3057. The spent solid catalyst can be contaminated with compounds such as heavy polycyclic aromatic molecules, sulfur, nitrogen and/or metals. Disposal of the spent solid catalyst as a waste material incurs substantial expense and entails environmental considerations.

Technology providers for slurry phase hydrocracking are listed in Table 1.

TABLE 1

| Technology | Licensor | Catalysts |
|---|---|---|
| MICROCAT-RC ™ | Exxon Mobil | phosphomolybdic acid and |
| | | molybdenum naphthenate |
| Veba Combi Cracker (VCC ™) | KBR | Red mud containing iron |
| Hydrocracking Distillation | Intevep | Natural ore |
| (HDH) | | |
| Super Oil Cracking (SOC) | Ashi Kasei | dispersed superfine powder and |
| | | transition metallic compound |
| LC-SLURRY | CLG | Ni, Mo |
| Eni slurry technology (EST) | Eni Technology | Dispersed Mo, Ni, V, Co, Fe |
| CANMET | Canadian Energy Mines | FeSO4 |
| | and Resources | |
| Uniflex | UOP | MoO3/H3PO4 |
| Kobelco | SPH | limonite ore Fe as active phase |
| Headwaters HC3 technology | HC3 | iron pentacarbonyl or molybdenum |
| | | 2-ethyl hexanoate |

In general, the types of catalysts used in slurry phase hydrocracking include heterogeneous solid powder catalysts or homogeneously dispersed catalysts. Heterogeneous solid powder catalysts include powder containing at least one metal such as cobalt, molybdenum, nickel or iron, in a salt form, as organometallics or as metals with ligands. Supported catalysts including metal impregnated alumina or silica-alumina are also used. Homogeneous dispersed catalysts include metals and other components to convert the metal to its active phase prior to the reactor or in the reactor. A summary of the catalysts for various known technologies is provided in Table 1. These are typically used in ppmw quantities (except FeSO₄ used in the CANMET technology and limonite ore Fe used in the Kobelco technology, used at a percentage level).

Separately, plastics including waste plastic is ubiquitous. Their chemical makeup varies widely and includes synthetic or semisynthetic organic polymers of mainly carbon and hydrogen. There are other constituents, including additives to change its composition and properties such as fillers, colorant, plasticizers, stabilizers, anti-oxidants, flame retardants, or ultraviolet (UV) light absorbers, as well as remnants of chemicals used during preparation such as antistatic agents, blowing agents, lubricants, polylactic acid or cellulosic. Types of plastic polymers include polyethylene terephthalate (PET), high-density polyethylene (HDPE), polyvinyl chloride (PVC), polypropylene (PP), polystyrene (PS) and low-density polyethylene (LDPE). Plastic polymers are composed of chains of linked monomer subunits. If identical monomers are joined a homopolymer is formed. Different monomers are also linked to form copolymers. Homopolymers and copolymers may be straight chains or branched chains.

Plastics that are solid at ambient conditions are in the form of amorphous, crystalline solids or semicrystalline (crystallites) solids. Plastics are typically poor conductors of heat and electricity, and most can be characterized as insulators with high dielectric strength. Glassy polymers tend to be stiff (e.g., polystyrene). Thin sheets of these polymers can be used as films (e.g., polyethylene). Plastics tend to be durable, with a slow rate of degradation, and while the actual degradation rate is highly specific to the type of plastic and the disposal environment, it is well regarded as ecologically detrimental.

Pure plastics are generally insoluble in water and nontoxic. However, many of the other chemicals used as additives and remnants from manufacturing are toxic and may leach into the environment. Examples of toxic additives include phthalates. Nontoxic polymers may also degrade into chemicals when they are heated or pyrolyzed. Plastics pyrolyze at high temperatures and polymers can be converted into underlying monomers as gas or liquids and recovered. However, additional chemicals undesirably remain in the pyrolysis products.

In regard to the above background information, the present disclosure is directed to a technical solution for an alternative catalyst material, including as catalysts used in slurry-phase hydrocracking of hydrocarbon oil, while utilizing waste materials in an environmentally friendly manner.

### SUMMARY OF THE DISCLOSURE

The present disclosure relates to methods for manufacturing embedded slurry-phase hydrocracking catalyst particles having catalytic material embedded in a plastic carrier. Catalytic material effective for slurry-phase hydrocracking, and molten plastic materials, are mixed, and the embedded slurry-phase hydrocracking catalyst particles are formed from the mixture.

In certain embodiments, a process for manufacturing embedded slurry-phase hydrocracking catalyst particles is provided. The embedded slurry-phase hydrocracking catalyst particles have catalytic material embedded in a plastic carrier. The process comprises mixing catalytic material effective for slurry-phase hydrocracking, and molten plastic materials, to form a mixture; and forming embedded slurry-phase hydrocracking catalyst particles from the mixture.

In certain embodiments, embedded slurry-phase hydrocracking catalyst particles are provided, comprising catalytic material effective for slurry-phase hydrocracking embedded in a plastic carrier obtained from waste plastic material.

In certain embodiments, the embedded slurry-phase hydrocracking catalyst particles have an average cross-sectional dimension of about 0.01-10.0 mm. In certain embodiments, an average particle aspect ratio is about 1:1-8:1.

In certain embodiments, the molten plastic materials are formed by melting solid waste plastic materials. In certain embodiments, the waste plastic materials are formed of polymers selected from the group of polymer types consisting of olefins, carbonates, aromatics, sulfones, fluorinated hydrocarbons, chlorinated hydrocarbons, acyrilnitriles, and combinations of two or more of the foregoing polymer types. In certain embodiments, the waste plastic materials are formed of polymers selected from the group consisting of polyethylene, polypropylene, polycarbonate, polystyrene, polyether sulfone, polytetrafluoroethylene, polyvinyl chloride, polyacrylonitrile, and combinations of two or more of the foregoing polymers.

In certain embodiments, the solid waste plastic materials are shredded, granulated, and/or formed into particulates prior to melting.

In certain embodiments, wherein the waste plastic materials are melted by heating to a temperature of about 0.1-40° C. above the melting point of the waste plastic materials. In certain embodiments, the waste plastic materials comprise a combination of two or more polymer types or polymers and wherein the waste plastic materials are melted by heating to a temperature above the melting point of the polymer types or polymers characterized by the highest melting point.

In certain embodiments, the waste plastic materials further comprise one or more of: coating material selected from the group consisting of acetone and methanol; an additive selected from the group consisting of fillers, colorants, plasticizers, stabilizers, anti-oxidants, flame retardants, and ultraviolet (UV) light absorbers; a manufacturing remnant material selected from the group consisting of antistatic agents, blowing agents, lubricants, polylactic acid and cellulosic; or phthalates.

In certain embodiments, the catalytic material comprises one or more of a transition metal complex, a precursor containing a metal, or a ligand containing a metal, wherein the metal is selected from the group consisting of Mo, W, Ni, Co, Fe, Ru, Cr and combinations of two or more of the foregoing.

In certain embodiments, wherein the catalytic material comprises a transition metal complex and an aromatic bottoms comprising C9 aromatics, C10 aromatics, C11 aromatics, C11+ aromatics, or a combination thereof, wherein the transition metal complex is dissolved or dispersed in the aromatic bottoms, wherein the transition metal complex comprises ligands, organometallics, salts, oxides, sulfides, or a combination thereof, and wherein a metal of the transition metal complex is selected from the group consisting of Mo, W, Ni, Co, Fe, Ru, Cr and combinations of two or more of the foregoing. In certain embodiments, the ligands comprise oxygen groups, and wherein the oxygen groups are bonded to a metal. In certain embodiments, the transition metal complex comprises bis(acetylacetonato)dioxomolybdenum(VI), molybdenum trioxide, molybdenum hexacarbonyl, or a combination thereof. In certain embodiments, the transition metal complex comprises bis(acetylacetonato)dioxomolybdenum(VI) and the aromatic bottoms comprises at least 60 weight percent of monoaromatic hydrocarbons.

In certain embodiments, the catalytic material comprises a transition metal complex, and a disulfide oil, wherein the disulfide oil is a reaction product of a mercaptan oxidation reaction, the metal complex is dissolved in the disulfide oil to form a mixed catalyst composition, and at least a portion of the mixed catalyst composition is transferred to a slurry-phase hydrocracking unit to form the catalyst for processing in the slurry-phase hydrocracking reaction zone, and wherein a metal of the transition metal complex is selected from the group consisting of Mo, W, Ni, Co, Fe, Ru, Cr and combinations of two or more of the foregoing. In certain embodiments, the transition metal complex comprises ligands including oxygen groups, and wherein the oxygen groups are bonded to a metal. In certain embodiments, the transition metal complex comprises bis(acetylacetonato)dioxomolybdenum(VI), molybdenum trioxide, molybdenum hexacarbonyl, or a combination thereof. In certain embodiments, the disulfide oil comprises dimethyldisulfide, diethyldisulfide, methylethyldisulfide, or a combination thereof. In certain embodiments, the concentration of the transition metal complex is greater than a solubility limit of the transition metal complex, or from 100 ppmw to 10,000 ppmw.

In certain embodiments, the catalytic material comprises: a disulfide oil and a first metal complex comprising at least one transition metal selected from the group consisting of molybdenum, cobalt, nickel, tungsten, iron, and combinations of these; and a plurality of ligands bonded to the at least one transition metal, wherein the plurality of ligands comprises at least one first ligand selected from the group consisting of dimethylsulfide, dimethyldisulfide, diethylsulfide, diethyldisulfide, methylethylsulfide, and methylethyldisulfide; the transition metal is bonded to a sulfur atom of the at least one first ligand, and the disulfide oil is a reaction product of a mercaptan oxidation reaction. In certain embodiments, the disulfide oil comprises greater than or equal to 90 wt % of dimethyldisulfide, diethyldisulfide, methylethyldisulfide, or combinations thereof. In certain embodiments, the plurality of ligands comprises at least one second ligand that is different from the at least one first ligand and wherein the at least one second ligand comprises one or more of oxo, acetylacetonate, iodide, bromide, sulfide, thiocyanate, chloride, nitrate, azide, fluoride, hydroxide, oxalate, water, nitrite, isothiocyanate, acetonitrile, pyridine, ammonia, ethylenediamine, 2,2′-bipyridine, 1,10-phenanthroline, nitrile, triphenylphosphine, cyanide, carbon monoxide, or an organometallic ligand. In certain embodiments, the first metal complex comprises molybdenum(VI) dioxo acetylacetonate dimethylsulfide, molybdenum(VI) dioxo acetylacetonate di-dimethylsulfide, molybdenum(VI) dioxo dimethylsulfide methylethyldisulfide, or molybdenum sodium dioxo di-dimethylsulfide methylethyldisulfide and a concentration of the first metal complex is in the range of from 100 ppmw to 10,000 ppmw. In certain embodiments, a concentration of the first metal complex is greater than a solubility limit of the metal complex. In certain embodiments, the catalytic material further comprises a second metal complex comprising: at least one transition metal selected from the group consisting of molybdenum, cobalt, nickel, tungsten, iron, or combinations thereof, and at least one ligand, wherein the at least one ligand comprises one or more of oxo, acetylacetonate, iodide, bromide, sulfide, thiocyanate, chloride, nitrate, azide, fluoride, hydroxide, oxalate, water, nitrite, isothiocyanate, acetonitrile, pyridine, ammonia, ethylenediamine, 2,2′-bipyridine, 1,10-phenanthroline, nitrile, triphenylphosphine, cyanide, carbon monoxide, or an organometallic ligand. In certain embodiments, the transition metal of the first metal complex is the same as the transition metal of the second metal complex. In certain embodiments, the second metal complex comprises one or more of bis(acetylacetonato)dioxomolybdenum (VI), cobalt(III) acetylacetonate, acetylacetonato nickel, ferric tris(acetylacetonate), or sodium bis(acetylacetonato)dioxomolybdenum.

In certain embodiments, the embedded slurry-phase hydrocracking catalyst particles are bagged and transported to a slurry-phase hydrocracking unit.

In certain embodiments, a slurry-phase hydrocracking process is provided comprising reacting a slurry-phase hydrocracking feed comprising residue stream and/or a deasphalted residue stream and embedded slurry-phase hydrocracking catalyst particles as in any of the herein embodiments in a slurry-phase hydrocracking reaction zone in the presence of hydrogen to produce slurry-phase hydrocracking effluents, wherein hydrocarbons in the slurry-phase hydrocracking feed and in a plastic component of the embedded slurry-phase hydrocracking catalyst particles are cracked into free-radical hydrocarbons and wherein the free-radical hydrocarbons are stabilized by hydrogen from the hydrogen-containing gas. In certain embodiments, the slurry-phase hydrocracking process operates at a temperature in the range of from about 380-600° C., a pressure in the range of from about 100-250 bars, a liquid hourly space velocity in the range of from 0.1-4.0 h⁻¹, and a hydrogen standard liters per liter of hydrocarbon feed rate of about 500-2500.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

FIG. 1 is a simplified flow chart of steps for manufacture of embedded slurry-phase hydrocracking catalysts.

FIG. 2 is a simplified schematic diagram of a slurry hydrocracking process.

### DETAILED DESCRIPTION OF CERTAIN EMBODIMENTS OF THE DISCLOSURE

Provided herein are embedded slurry-phase hydrocracking catalyst particles, including an inactive slurry-phase hydrocracking catalyst carrier, a method of making embedded slurry-phase hydrocracking catalyst particles with an inactive slurry-phase hydrocracking catalyst carrier, methods of using embedded slurry-phase hydrocracking catalyst particles in a slurry hydrocracking system, and methods to recycle waste by use as a raw material as an inactive component of embedded slurry-phase hydrocracking catalyst particles.

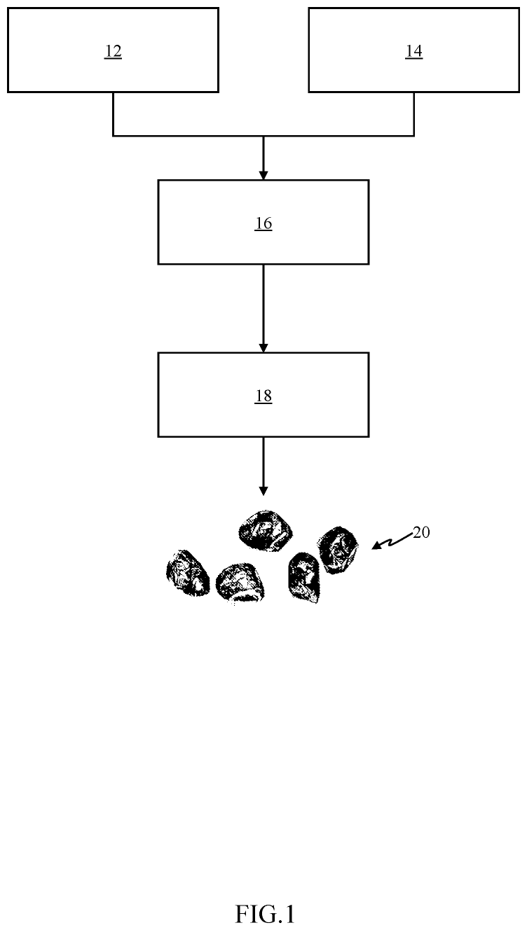

FIG. 1 depicts a flow chart of process according to embodiments herein schematically depicting steps for manufacture of embedded slurry-phase hydrocracking catalysts 20. The embedded slurry-phase hydrocracking catalyst particles 20 comprise slurry-phase hydrocracking catalyst materials embedded in plastic component as an inactive carrier body. The slurry-phase hydrocracking catalytic materials 12 and the plastic materials 14 as the inactive component are provided. The plastic materials 14 are provided in a liquid or molten form before or during the step of mixing 16. The slurry-phase hydrocracking catalytic materials 12 are provided in a liquid form, a solid form, or a mixed phase of solid and liquid. The slurry-phase hydrocracking catalytic materials 12 and the plastic materials 14 are mixed 16 to form a mixture that is formed 18 into embedded slurry-phase hydrocracking catalyst particles 20. In certain embodiments the slurry-phase hydrocracking catalytic materials 12 and molten plastic materials 14 are mixed and kneaded to form a well dispersed mixture having the consistency of a dough, and that mixture is formed 18 into embedded slurry-phase hydrocracking catalyst particles 20.

The final shapes and sizes of the embedded catalyst carriers 20 are generally determined in the forming step 18. The embedded catalyst carriers 20 are formed into one or more of several possible shapes such as spheres, spheroids, cylindrical extrudates, or shaped forms such as a trilobes or a quadrilobes, using for instance suitable dies. Spherical or spheroidal particles may be obtained by drop coagulation (also known as “oil dropping”). Other spherical or spheroidal processes include marumerization and spheronization after extrusion. Non spherical shapes can be obtained by extrusion. For example, the mixture from step 18 can be in the form of a wet extrudable dough or paste, which is extruded through a die with perforations. The extrudate is characterized by a suitable cross-sectional shape generally corresponding to that of the die, including but not limited to circular, oval, ovoid, racetrack, triangular, Reuleaux triangular, quadrilateral, trilobe, quadrilobed, or a squircle (or a three-sided shape or other multi-sided shape with rounded corners). The extrudate is dried and divided into short pieces as the embedded catalyst carriers 20. In certain embodiments the embedded catalyst carriers 20 are characterized by an average cross-sectional dimension (diameter and/or length) in the range of about 0.01-10, 0.01-5, 0.05-10, 0.05-5, 0.1-10, 0.1-5, 0.5-10, 0.5-5, 1-10, or 1-5 mm. In certain embodiments the embedded catalyst carriers 20 are in the form of extrudates of a suitable cross-sectional shape with an average cross-sectional diameter in the range of about 0.01-10, 0.01-5, 0.05-10, 0.05-5, 0.1-10, 0.1-5, 0.5-10, 0.5-5, 1-10, or 1-5 mm, and with an average particle aspect ratio in the range of about 1.5:1-8:1, 1.5:1-5:1, 2:1-8:1, 2:1-5:1 or 2:1-4:1.

The plastic materials 14 are typically initially provided in solid form, and heated for conversion from solid form into a liquid or molten phase. In certain embodiments, the plastic materials 14 such as waste plastic materials initially in solid phase are heated to provide a liquid or molten phase prior to mixing 16 together with the slurry-phase hydrocracking catalytic materials 12. In certain embodiments, the plastic materials 14 such as waste plastic materials are preheated with at least a portion thereof remaining in a solid phase, thereby providing a mixed phase of a solid phase and a liquid or molten phase to the step of mixing 16, and wherein mixing 16 the plastic materials 14 together with the slurry-phase hydrocracking catalytic materials 12 occurs in the presence of additional heat. In certain embodiments, the plastic materials 14 such as waste plastic materials are provided as solid material, and wherein mixing 16 the plastic materials 14 together with the slurry-phase hydrocracking catalytic materials 12 occurs in the presence of heat to convert the solid phase of the plastic materials into a liquid or molten phase whilst mixing.

The plastic materials 14, in an initial solid phase, are heated to at least the melting point of the polymer or polymers that comprise the plastic materials. In certain embodiments the temperature of heating for conversion from solid to liquid or molten phase is about 0.1-40, 1-40, 5-40, 10-40, 0.1-20, 1-20, 5-20 or 10-20° C. above the melting point of a polymer forming the plastic materials 14. In certain embodiments plastic materials 14 such as waste plastic materials are in the form of a mixture of different types of polymers, and heating is to a temperature of at least that of the highest melting point polymer component of the mixture. In certain embodiments the temperature of heating for conversion from solid to liquid or molten phase is at least about 83° C., for example about 83-300, 90-300, 120-300, 150-300, 200-300, or 250-300° C. In certain embodiments the temperature of heating for conversion from solid to liquid or molten phase is about 0.1-40, 1-40, 5-40, 10-40, 0.1-20, 1-20, 5-20 or 10-20° C. above the highest melting point polymer component of the mixture plastic materials 14.

In certain embodiments all or a portion of the plastic materials 14 that are heated in the as-provided from waste plastic materials including bags, sheets, containers, and/or other forms of waste or discarded polymer-containing materials. In certain embodiments the plastic materials 14 are provided as shredded, granulated, and/or particulate form, depending on the type and form of the polymer material. In certain embodiments the plastic materials 14 are shredded, granulated, and/or formed into particulates, depending on the type and form of the polymer material. In certain embodiments flexible or semi-rigid forms of polymer material such as waste plastic material (for instance waste or discarded plastic bags, waste or discarded semi-rigid containers, waste or discarded textiles, or off-spec fresh plastic base material typically sent to reclamation) are shredded prior to heating for conversion from solid to liquid or molten phase. In certain embodiments shredded material is in the form of strips possessing length dimensions of about 6-50, 6-20, 6-15, 10-50, 10-20, 10-15 or 20-50 mm, width dimensions to provide strips of a length to width ratio of about 5:1-100:1 or about 5:1-50:1, and a thickness depending on characteristics of the underlying flexible or semi-rigid waste plastic material, for example about 0.01-1 or 0.01-0.1 mm. In certain embodiments shredded material is in the form of flakes (e.g., cross-shredded) possessing width and length dimensions of about 6-50, 6-20, 6-15, 10-50, 10-20, 10-15 or 20-50 mm, and a thickness depending on characteristics of the underlying flexible or semi-rigid waste plastic material, for example about 0.01-1 or 0.01-0.1 mm. In certain embodiments semi-rigid or rigid forms of polymer material such as waste plastic material (for instance waste or discarded semi-rigid or rigid containers, waste or discarded components, or off-spec fresh plastic base material typically sent to reclamation) are granulated prior to heating for conversion from solid to liquid or molten phase, for example into particles or granules having average cross-sectional dimensions of about 6-50, 6-20, 6-15, 10-50, 10-20, 10-15 or 20-50 mm.

The plastic materials 14 are polymers selected from the group of polymer types consisting of olefins, carbonates, aromatics, sulfones, fluorinated hydrocarbons, chlorinated hydrocarbons, acyrilnitriles, and combinations of two or more of the foregoing polymer types. For example, the plastic materials 14 may be selected from the group of polymers consisting of polyethylene, polypropylene, polycarbonate, polystyrene, polyether sulfone, polytetrafluoroethylene, polyvinyl chloride, polyacrylonitrile, polymers containing diphenylcarbonate, and combinations of two or more of the foregoing polymers.

In one embodiment the plastic material 14 comprises, consists essentially of, or consists of polyethylene (an olefin polymer type) having a melting point in the range of about 115-135° C. The polyethylene can be provided in the form of a waste plastic (single-use waste plastic or discarded reusable plastic), such as from flexible plastic bags, films and/or sheets, and/or rigid or semi-rigid plastic containers.

In one embodiment the plastic material 14 comprises, consists essentially of, or consists of polypropylene (an olefin polymer type) having a melting point in the range of about 135-165° C. The polypropylene can be provided in the form of a waste plastic (single-use waste plastic or discarded reusable plastic), such as from flexible plastic bags, films and/or sheets, rigid or semi-rigid plastic containers, and/or off-spec polypropylene.

In one embodiment the plastic material 14 comprises, consists essentially of, or consists of polycarbonate (a carbonate polymer type) including polycarbonates formed from diphenylcarbonate and diphenylolpropane (bisphenol A), with certain components having a melting point of about 78-82° C., up to a melting point of about 295-315° C. The polycarbonate can be provided in the form of a waste plastic (single-use waste plastic or discarded reusable plastic) such as from rigid or semi-rigid plastic containers or sheets, and/or off-spec polycarbonate.

In one embodiment the plastic material 14 comprises, consists essentially of, or consists of polystyrene (an aromatic polymer type) having a melting point of about 240° C. The polystyrene can be provided in the form of a waste plastic such as: general-purpose polystyrene such as from discarded packaging, household goods or electronics; high impact polystyrene such as from discarded toys, housewares, packaging, bottles, or electronics; expanded polystyrene such as from discarded insulation and packaging; and/or off-spec polystyrene.

In one embodiment the plastic material 14 comprises, consists essentially of, or consists of polyether sulfone (a sulfone polymer type) having a melting point in the range of about 227-238° C. The polyether sulfone can be provided in the form of a waste plastic such as discarded components from automobiles and medical devices, and/or off-spec polyether sulfone.

In one embodiment the plastic material 14 comprises, consists essentially of, or consists of polytetrafluoroethylene (a fluorinated hydrocarbon polymer type) having a melting point of about 327° C. The polytetrafluoroethylene can be provided in the form discarded automotive or mechanical components, chemical industry containers and vessels, electrical insulation, flexible printed circuit boards, or semiconductor parts; and/or off-spec polytetrafluoroethylene.

In one embodiment the plastic material 14 comprises, consists essentially of, or consists of polyvinyl chloride (a chlorinated hydrocarbon polymer type) having a melting point in the range of about 100-260° C. The polyvinyl chloride can be provided in the form of a waste plastic such as discarded pipes, construction materials or signs; and/or off-spec polyvinyl chloride.

In one embodiment the plastic material 14 comprises, consists essentially of, or consists of polyacrylonitrile (an acyrilnitrile polymer type) having a melting point of about 300° C. The polyacrylonitrile can be provided in the form of a waste plastic such as discarded textiles containing polyacrylonitrile synthetic fibers; and/or off-spec polyacrylonitrile.

In certain embodiments, the plastic materials 14 are plastic materials including a polymer and one or more polymer coating materials, suitable solvent include acetone or methanol (for example, as used with acrylonitriles). In certain embodiments, the plastic materials 14 are plastic materials including an underlying polymer and one or more additives that was provided in the plastic materials together with the underlying polymer to change the composition and properties of the underlying polymer including one or more fillers, colorants, plasticizers, stabilizers, anti-oxidants, flame retardants, or ultraviolet (UV) light absorbers. In certain embodiments, the plastic materials 14 are plastic materials including an underlying polymer and remnants of chemicals used during preparation the plastic materials including one or more of antistatic agents, blowing agents, lubricants, polylactic acid or cellulosic. In certain embodiments the plastic materials 14 are waste plastic materials containing phthalates. In certain embodiments the plastic materials 14 are waste plastic materials comprising polyvinyl chloride containing phthalates as plasticizers.

In certain embodiments the plastic materials 14 comprise, consist essentially of, or consist of waste plastic materials obtained from industrial, municipal or other sources of solid plastic waste.

In some embodiments, effective catalytic materials for slurry-phase hydrocracking and that are included as the catalytic material 12 herein include heterogeneous solid (powder or particles) catalytic material or catalytic materials that would typically be homogeneously dispersed. In certain embodiments catalytic materials comprise one or more of a transition metal complex, a precursor, or a ligand. In certain embodiments catalytic materials comprises a metal selected from the group consisting of Mo, W, Ni, Co, Fe, Ru, Cu, and combinations comprising two or more of the foregoing metals. In certain embodiments catalytic materials comprise heterogeneous powder or particles such as oxides of iron, coal, activated carbon, alumina, silica-alumina, and other known materials. In certain embodiments powders can be nano-sized particles having average cross-sectional dimensions of about 1-5000, 10-5000, 50-5000, 100-5000, or 500-5000 nm. In certain embodiments particles include supported catalyst particles having average cross-sectional dimensions of about 0.01-4, 0.1-4, 1-4 mm.

In some embodiments, effective catalytic materials as catalytic material 12 for manufacture of embedded slurry-phase hydrocracking catalyst particles 20 and their use in slurry-phase hydrocracking comprise a transition metal complex and an aromatic bottoms comprising C9 aromatics, C10 aromatics, C11 aromatics, C11+ aromatics, or a combination thereof, wherein the transition metal complex is dissolved or dispersed in the aromatic bottoms, wherein the transition metal complex comprises ligands, organometallics, salts, oxides, sulfides, or a combination thereof. In some embodiments, the ligands comprise oxygen groups, and the oxygen groups are bonded to a metal. In some embodiments, the transition metal complex comprises bis(acetylacetonato)dioxomolybdenum(VI), molybdenum trioxide, molybdenum hexacarbonyl, or a combination thereof. In some embodiments, the transition metal complex comprises bis(acetylacetonato)dioxomolybdenum(VI) and the aromatic bottoms comprises at least 60 weight percent of monoaromatic hydrocarbons.

In some embodiments, effective catalytic materials as catalytic material 12 for manufacture of embedded slurry-phase hydrocracking catalyst particles 20 and their use in slurry-phase hydrocracking comprise a transition metal complex, and a disulfide oil, wherein the disulfide oil is a reaction product of a mercaptan oxidation reaction, the metal complex is dissolved in the disulfide oil to form a mixed catalyst composition, and at least a portion of the mixed catalyst composition is transferred to a slurry-phase hydrocracking unit to form the catalyst for processing in the slurry-phase hydrocracking reaction zone. In some embodiments, the metal complex comprises ligands including oxygen groups, and wherein the oxygen groups are bonded to a metal.

In some embodiments, the metal complex comprises bis(acetylacetonato)dioxomolybdenum(VI), molybdenum trioxide, molybdenum hexacarbonyl, or a combination thereof. In some embodiments, the disulfide oil comprises dimethyldisulfude, diethyldisulfide, methylethyldisulfide, or a combination thereof. In some embodiments, the concentration of the metal complex is greater than a solubility limit of the metal complex, or from 100 ppmw to 10,000 ppmw.

In some embodiments, effective catalytic materials as catalytic material 12 for manufacture of embedded slurry-phase hydrocracking catalyst particles 20 and their use in slurry-phase hydrocracking comprise a disulfide oil and a first metal complex comprising at least one transition metal selected from the group consisting of molybdenum, cobalt, nickel, tungsten, iron, and combinations of these; and a plurality of ligands bonded to the at least one transition metal, wherein the plurality of ligands comprises at least one first ligand selected from the group consisting of dimethylsulfide, dimethyldisulfide, diethylsulfide, diethyldisulfide, methylethylsulfide, and methylethyldisulfide; the transition metal is bonded to a sulfur atom of the at least one first ligand, and the disulfide oil is a reaction product of a mercaptan oxidation reaction. In some embodiments, the disulfide oil comprises greater than or equal to 90 wt % of dimethyldisulfide, diethyldisulfide, methylethyldisulfide, or combinations thereof. In some embodiments, the plurality of ligands comprises at least one second ligand that is different from the at least one first ligand and wherein the at least one second ligand comprises one or more of oxo, acetylacetonate, iodide, bromide, sulfide, thiocyanate, chloride, nitrate, azide, fluoride, hydroxide, oxalate, water, nitrite, isothiocyanate, acetonitrile, pyridine, ammonia, ethylenediamine, 2,2′-bipyridine, 1,10-phenanthroline, nitrile, triphenylphosphine, cyanide, carbon monoxide, or an organometallic ligand. In some embodiments, the first metal complex comprises molybdenum(VI) dioxo acetylacetonate dimethylsulfide, molybdenum(VI) dioxo acetylacetonate di-dimethylsulfide, molybdenum(VI) dioxo dimethylsulfide methylethyldisulfide, or molybdenum sodium dioxo di-dimethylsulfide methylethyldisulfide and a concentration of the first metal complex is in the range of from 100 ppmw to 10,000 ppmw. In some embodiments, the concentration of the first metal complex is greater than a solubility limit of the metal complex. In some embodiments, the catalyst for processing in the slurry-phase hydrocracking reaction zone further comprises a second metal complex comprising at least one transition metal selected from the group consisting of molybdenum, cobalt, nickel, tungsten, iron, or combinations thereof, and at least one ligand, wherein the at least one ligand comprises one or more of oxo, acetylacetonate, iodide, bromide, sulfide, thiocyanate, chloride, nitrate, azide, fluoride, hydroxide, oxalate, water, nitrite, isothiocyanate, acetonitrile, pyridine, ammonia, ethylenediamine, 2,2′-bipyridine, 1,10-phenanthroline, nitrile, triphenylphosphine, cyanide, carbon monoxide, or an organometallic ligand. In some embodiments, the transition metal of the first metal complex is the same as the transition metal of the second metal complex. In some embodiments, the second metal complex comprises one or more of bis(acetylacetonato)dioxomolybdenum (VI), cobalt(III) acetylacetonate, acetylacetonato nickel, ferric tris(acetylacetonate), or sodium bis(acetylacetonato)dioxomolybdenum.

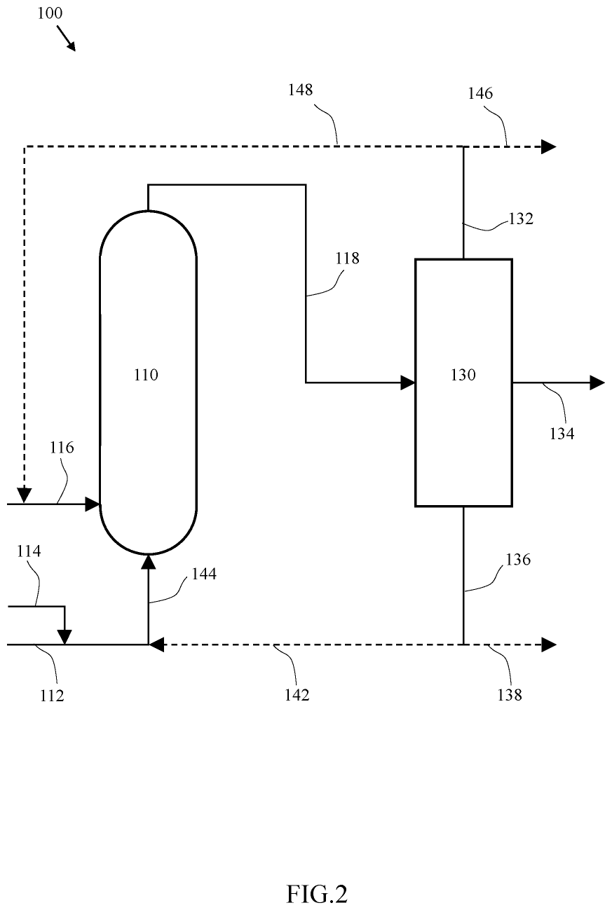

In certain embodiments a method comprises carrying out slurry hydrocracking using the embedded slurry-phase hydrocracking catalyst particles disclosed herein, including embedded slurry-phase hydrocracking catalyst particles formed from waste plastic or waste plastic containing one or more of a coating material, additive, or manufacturing remnant material. An embodiment of a slurry hydrocracking system 100 is schematically shown in FIG. 2. The system 100 generally includes a slurry-phase hydrocracking zone 110 and a fractionator 130. In certain embodiments a slurry-phase hydrocracking zone 110 generally includes plug-flow type tubular reactors operating in the up flow or down flow (not shown) modes. A feedstock 112 is combined with a slurry catalyst 114, and hydrocarbon components are cracked in slurry-phase hydrocracking zone 110 in the presence of hydrogen 116 to produce a slurry hydrocracking zone effluents 118. The slurry catalyst 114 comprises embedded slurry-phase hydrocracking catalyst particles such as the embedded slurry-phase hydrocracking catalyst particles 20 manufactured as described herein. Accordingly, hydrocarbon components that are cracked include those from the feedstock 112 and from the plastic component of the embedded slurry-phase hydrocracking catalyst particles that form all or part of the slurry catalyst 114.

In some embodiments, the slurry-phase hydrocracking reaction zone 110 operates by dispersing an effective amount of slurry catalyst 114 in the slurry-phase feedstock 112. An effective amount of a hydrogen-containing gas 116 is passed through the reactant-catalyst dispersion, wherein hydrocarbons in the slurry-phase hydrocracking feed and from the plastic material of the catalyst particles are cracked into free-radical hydrocarbons of reduced size and wherein the free-radical hydrocarbons are stabilized by hydrogen from the hydrogen-containing gas. The slurry hydrocracking zone effluents 118 includes unreacted hydrogen and which is under hydrogen partial pressure.

In some embodiments, the feedstock 112 described herein can be heavy hydrocarbon feedstocks derived from natural sources including crude oil, condensates, bitumen, tar sands and shale oils, or from refinery processes including atmospheric or vacuum residue, or products from coking, visbreaker and fluid catalytic cracking operations. The heavy hydrocarbon feedstock mixture is characterized by a bottom boiling point of about 320, 350 or 400° C., to an upper boiling point of about 1000, 1500 or 2000° C., for example in the range of about 320-2000, 320-1500, 320-1000, 350-2000, 350-1500, 350-1000, 400-2000, 400-1500 or 400-1000° C.

The slurry hydrocracking zone effluents 118 are routed to the fractionator 130 for separation into a gas stream 132, for example including LPG and/or light ends; a converted products stream 134, for example including naphtha (one or more separate streams of light naphtha, heavy naphtha and/or full range naphtha), and middle distillates; and a residue stream 136 containing solid catalyst. In some embodiments, converted products stream 134 can be further separated (not shown) into one or more of gasoline, mid distillates, and vacuum gas oil. In some embodiments, all or a portion of the residue stream 136 can be recycled as stream 142 to the slurry-phase hydrocracking zone 110. In these embodiments, residue stream, catalyst and slurry feedstock are combined as feedstream 144 before entering slurry-phase hydrocracking zone 110.

In some embodiments the residue stream 136 can be recycled back to the slurry-phase hydrocracking zone 110 to extinction. Alternatively, in some embodiments, all or a portion of the residue stream 136 can be processed in a downstream unit (not shown) as stream 138. In additional embodiments herein, additional chemicals from the waste plastic containing one or more of a coating material, additive, or manufacturing remnant material are not converted, or partially converted, and remaining constituents are discharged from the system in the residue stream 136.

Gas stream 132 comprises hydrogen and light hydrocarbons. In some embodiments all or a portion of the gas stream 132 can be discharged as gas stream 146. In some embodiments all or a portion of the gas stream 132 can be optionally separated (not shown) to produce a hydrogen-rich stream 148 that can be recycled back to the slurry-phase hydrocracking zone 110.

The viscosity and therefore the pumpability of the mixture of the heavy bottoms and solid catalyst mixture from the separator can be affected by various factors, including the nature of the original feedstream, the extent of recycled residue materials present and the physical characteristics of the catalyst(s) used in the slurry hydrocracking process. If the physical state of the heavy bottoms and catalyst mixture is solid to viscous, or a semi-solid liquid, it can be heated to a temperature and/or the pressure raised to render it sufficiently fluid to be pumped. The temperature can range from about 25-200° C. and a pressure from about 1-100 bars.

Slurry-phase hydroprocessing operates at relatively high temperatures and high pressures. Because of the high severity of the process, a relatively higher conversion rate can be achieved, and the plastic component of the embedded slurry-phase hydrocracking catalyst particles becomes part of the hydrocarbon pool for cracking. In general, in a slurry bed reactor, the catalyst is suspended in a liquid through which a gas is bubbled. The mechanism in a slurry bed reactor is a thermal cracking process and is based on free radical formation. The free radicals formed are stabilized with hydrogen in the presence of catalysts, thereby preventing coke formation.

In some embodiments, a slurry bed reactor can be a two-or-three phase reactor, depending on the type of catalysts utilized. A two-phase system includes gas and liquid when homogeneous catalysts are employed, and a three-phase system includes gas, liquid and solid when small particle size heterogeneous catalysts are employed. The soluble liquid precursor or small particle size catalysts permit high dispersion of catalysts in the liquid resulting in intimate contact between catalyst and feedstock, thus maximizing the conversion rate.

In certain embodiments, slurry-phase hydrocracking zone 110 includes a hydrocracking slurry bed reactor operating under the following conditions: a temperature in the range of about 380-600, 380-550, 380-500, 400-600, 400-550, 400-500, 420-600, 420-550, or 420-500° C., a pressure in the range of about 100-250, 100-220, 100-200, 120-250, 120-220, 120-200, 130-250, 130-220, or 130-200 bars, a LHSV in the range of about 0.1-4.0, 0.1-1.0, 0.1-0.5, 0.2-4.0, 0.2-1.0, 0.2-0.5, 0.3-4.0, 0.3-1.0, or 0.3-0.5 h⁻¹, and a hydrogen standard liters per liter of hydrocarbon feed rate of about 500-2500, 500-2000, 500-1800, 800-2500, 800-2000, 800-1800, 1000-2500, 1000-2000, or 1000-1800.

As used herein, the term “stream” (and variations of this term, such as hydrocarbon stream, feedstream, product stream, and the like) may include one or more of various hydrocarbon compounds, such as straight chain, branched or cyclical alkanes, alkenes, alkadienes, alkynes, alkylaromatics, alkenyl aromatics, condensed and non-condensed di-, tri- and tetra-aromatics, and gases such as hydrogen and methane, C2+ hydrocarbons and further may include various impurities.

The term “zone” refers to an area including one or more equipment, or one or more sub-zones. Equipment may include one or more reactors or reactor vessels, heaters, heat exchangers, pipes, pumps, compressors, and controllers. Additionally, an equipment, such as dryer, or vessels, further may be included in one or more zones.

The term “crude oil” as used herein refers to petroleum extracted from geologic formations in its unrefined form. Crude oil suitable as the source material for the processes herein include Arabian Heavy, Arabian Light, Arabian Extra Light, other Gulf crudes, Brent, North Sea crudes, North and West African crudes, Indonesian, Chinese crudes, North or South American crudes, Russian and Central Asian crudes, or mixtures thereof. The crude petroleum mixtures can be whole range crude oil or topped crude oil. As used herein, “crude oil” also refers to such mixtures that have undergone some pre-treatment such as water-oil separation; and/or gas-oil separation; and/or desalting; and/or stabilization. In certain embodiments, crude oil refers to any of such mixtures having an API gravity (ASTM D287 standard), of greater than or equal to about 10°, 20°, 30°, 32°, 34°, 36°, 38°, 40°, 42° or 44°.

The term “condensates” refers to hydrocarbons separated from natural gas stream. As used herein, “condensates” also refers to such mixtures that have undergone some pre-treatment such as water-oil separation; and/or gas-oil separation; and/or desalting; and/or stabilization. In certain embodiments, condensates refer to any of such mixtures having an API gravity (ASTM D287 standard), of greater than or equal to about 45, 50, 60, or 65°.

The acronym “LPG” as used herein refers to the well-known acronym for the term “liquefied petroleum gas,” and generally is a mixture of C3-C4 hydrocarbons. In certain embodiments, these are also referred to as “light ends.”

As used herein, all boiling point ranges relative to hydrocarbon fractions derived from crude oil via atmospheric and/or vacuum distillation shall refer to True Boiling Point values obtained from a crude oil assay, or a commercially acceptable equivalent.

The term “naphtha” as used herein refers to hydrocarbons having a nominal boiling range of about 20-205, 20-193, 20-190, 20-180, 20-170, 32-205, 32-193, 32-190, 32-180, 32-170, 36-205, 36-193, 36-190, 36-180 or 36-170° C.

The term “light naphtha” as used herein refers to hydrocarbons having a nominal boiling range of about 20-110, 20-100, 20-90, 20-88, 32-110, 32-100, 32-90, 32-88, 36-110, 36-100, 36-90 or 36-88° C.

The term “heavy naphtha” as used herein refers to hydrocarbons having a nominal boiling range of about 90-205, 90-193, 90-190, 90-180, 90-170, 93-205, 93-193, 93-190, 93-180, 93-170, 100-205, 100-193, 100-190, 100-180, 100-170, 110-205, 110-193, 110-190, 110-180 or 110-170° C.

In certain embodiments naphtha, light naphtha and/or heavy naphtha refer to such petroleum fractions obtained by crude oil distillation, or distillation of intermediate refinery processes as described herein.

In certain embodiments, the term “middle distillate” is used with reference to one or more straight run fractions from the atmospheric distillation unit, for instance containing hydrocarbons having a nominal boiling range of about 160-400, 160-380, 160-370, 160-360, 160-340, 170-400, 170-380, 170-370, 170-360, 170-340, 180-400, 180-380, 180-370, 180-360, 180-340, 190-400, 190-380, 190-370, 190-360, 190-340, 193-400, 193-380, 193-370, 193-360, or 193-340° C. In embodiments in which other terminology is used herein, the middle distillate fraction can also include all or a portion of AGO range hydrocarbons, all or a portion of kerosene, all or a portion of medium AGO range hydrocarbons, and/or all or a portion of heavy kerosene range hydrocarbons. In additional embodiments, term “middle distillate” is used to refer to fractions from one or more integrated operations boiling in this range.

The term “residue” as used herein refer to the bottom hydrocarbons having an initial boiling point corresponding to the end point of middle distillate range hydrocarbons, and having an end point based on the characteristics of the slurry hydrocracking zone effluents.

It is to be understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A process for manufacturing embedded slurry-phase hydrocracking catalyst particles having catalytic material embedded in a plastic carrier, the process comprising:
mixing catalytic material effective for slurry-phase hydrocracking, and molten plastic materials, to form a mixture; and
forming embedded slurry-phase hydrocracking catalyst particles from the mixture.

2. The method as in claim 1, wherein the embedded slurry-phase hydrocracking catalyst particles have an average cross-sectional dimension of about 0.01-10.0 mm.

3. The method as in claim 2, wherein an average particle aspect ratio is about 1:1-8:1.

4. The method as in claim 1, wherein the molten plastic materials are formed by melting solid waste plastic materials.

5. The method as in claim 4, wherein the waste plastic materials are formed of polymers selected from the group of polymer types consisting of olefins, carbonates, aromatics, sulfones, fluorinated hydrocarbons, chlorinated hydrocarbons, acyrilnitriles, and combinations of two or more of the foregoing polymer types.

6. The method as in claim 4, wherein the waste plastic materials are formed of polymers selected from the group consisting of polyethylene, polypropylene, polycarbonate, polystyrene, polyether sulfone, polytetrafluoroethylene, polyvinyl chloride, polyacrylonitrile, and combinations of two or more of the foregoing polymers.

7. The method as in claim 5, wherein the solid waste plastic materials are shredded, granulated, and/or formed into particulates prior to melting.

8. The method as in claim 5, wherein the waste plastic materials are melted by heating to a temperature of about 0.1-40° C. above the melting point of the waste plastic materials.

9. The method as in as in claim 5, wherein the waste plastic materials comprise a combination of two or more polymer types or polymers and wherein the waste plastic materials are melted by heating to a temperature above the melting point of the polymer types or polymers characterized by the highest melting point.

10. The method as in claim 5, wherein the waste plastic materials further comprise one or more of:
coating material selected from the group consisting of acetone and methanol;
an additive selected from the group consisting of fillers, colorants, plasticizers, stabilizers, anti-oxidants, flame retardants, and ultraviolet (UV) light absorbers;
a manufacturing remnant material selected from the group consisting of antistatic agents, blowing agents, lubricants, polylactic acid and cellulosic; or
phthalates.

11. The method as in claim 5, wherein the catalytic material comprises one or more of a transition metal complex, a precursor containing a metal, or a ligand containing a metal, wherein the metal is selected from the group consisting of Mo, W, Ni, Co, Fe, Ru, Cr and combinations of two or more of the foregoing.

12. The method as in claim 5, wherein the catalytic material comprises a transition metal complex and an aromatic bottoms comprising C9 aromatics, C10 aromatics, C11 aromatics, C11+ aromatics, or a combination thereof, wherein the transition metal complex is dissolved or dispersed in the aromatic bottoms, wherein the transition metal complex comprises ligands, organometallics, salts, oxides, sulfides, or a combination thereof, and wherein a metal of the transition metal complex is selected from the group consisting of Mo, W, Ni, Co, Fe, Ru, Cr and combinations of two or more of the foregoing.

13-15. (canceled)

16. The method as in claim 5, wherein the catalytic material comprises a transition metal complex, and a disulfide oil, wherein the disulfide oil is a reaction product of a mercaptan oxidation reaction, the metal complex is dissolved in the disulfide oil to form a mixed catalyst composition, and at least a portion of the mixed catalyst composition is transferred to a slurry-phase hydrocracking unit to form the catalyst for processing in the slurry-phase hydrocracking reaction zone, and wherein a metal of the transition metal complex is selected from the group consisting of Mo, W, Ni, Co, Fe, Ru, Cr and combinations of two or more of the foregoing.

17-20. (canceled)

21. The method as in claim 5, wherein the catalytic material comprises:
a disulfide oil and a first metal complex comprising
at least one transition metal selected from the group consisting of molybdenum, cobalt, nickel, tungsten, iron, and combinations of these; and
a plurality of ligands bonded to the at least one transition metal,
wherein the plurality of ligands comprises at least one first ligand selected from the group consisting of dimethylsulfide, dimethyldisulfide, diethylsulfide, diethyldisulfide, methylethylsulfide, and methylethyldisulfide; the transition metal is bonded to a sulfur atom of the at least one first ligand, and the disulfide oil is a reaction product of a mercaptan oxidation reaction.

22-25. (canceled)

26. The method of claim 21, wherein the catalytic material further comprises a second metal complex comprising:
at least one transition metal selected from the group consisting of molybdenum, cobalt, nickel, tungsten, iron, or combinations thereof; and
at least one ligand, wherein the at least one ligand comprises one or more of oxo, acetylacetonate, iodide, bromide, sulfide, thiocyanate, chloride, nitrate, azide, fluoride, hydroxide, oxalate, water, nitrite, isothiocyanate, acetonitrile, pyridine, ammonia, ethylenediamine, 2,2′-bipyridine, 1,10-phenanthroline, nitrile, triphenylphosphine, cyanide, carbon monoxide, or an organometallic ligand.

27. (canceled)

28. The method of claim 26, wherein the second metal complex comprises one or more of bis(acetylacetonato)dioxomolybdenum (VI), cobalt(III) acetylacetonate, acetylacetonato nickel, ferric tris(acetylacetonate), or sodium bis(acetylacetonato)dioxomolybdenum.

29. The method as in claim 5, further comprising bagging the embedded slurry-phase hydrocracking catalyst particles and transporting the bagged embedded slurry-phase hydrocracking catalyst particles to a slurry-phase hydrocracking unit.

30. Embedded slurry-phase hydrocracking catalyst particles comprising catalytic material effective for slurry-phase hydrocracking embedded in a plastic carrier obtained from waste plastic material.

31. A slurry-phase hydrocracking process comprising reacting a slurry-phase hydrocracking feed comprising residue stream and/or a deasphalted residue stream and embedded slurry-phase hydrocracking catalyst particles as in claim 5 in a slurry-phase hydrocracking reaction zone in the presence of hydrogen to produce slurry-phase hydrocracking effluents, wherein hydrocarbons in the slurry-phase hydrocracking feed and in a plastic component of the embedded slurry-phase hydrocracking catalyst particles are cracked into free-radical hydrocarbons and wherein the free-radical hydrocarbons are stabilized by hydrogen from the hydrogen-containing gas.

32. The slurry-phase hydrocracking process as claim 31 operating at a temperature in the range of from about 380-600° C., a pressure in the range of from about 100-250 bars, a liquid hourly space velocity in the range of from 0.1-4.0 h⁻¹, and a hydrogen standard liters per liter of hydrocarbon feed rate of about 500-2500.
